(19) United States
(12) Patent Application Publication
(10) Pub. No.: US 2014/0265720 A1
(43) Pub. Date: Sep. 18, 2014

(54) METHODS AND DEVICES RELATING TO CAPACITIVE MICROMACHINED DIAPHRAGMS AND TRANSDUCERS

(71) Applicant: The Royal Institution for the Advancement of Learning / McGill University, Montreal (CA)

(72) Inventors: Mourad El-Gamal, Brossard (CA); Qing Zhang, Montreal (CA); Paul-Vahe Cicek, Montreal (CA); Frederic Nabki, Montreal (CA)

(73) Assignee: The Royal Institution for the Advancement of Learning / McGill University, Montreal (CA)

(21) Appl. No.: 14/211,350

(22) Filed: Mar. 14, 2014

Related U.S. Application Data
(60) Provisional application No. 61/781,886, filed on Mar. 14, 2013.

(51) Int. Cl. G10K 9/12

(52) U.S. Cl. CPC G10K 9/12
USPC 310/300

(57) ABSTRACT

Monolithically integrated capacitive micromachined transducers (CMTs) offer combined process steps, shared layers, simplified packaging, and reduced die size by overlapping the CMTs with the integrated circuit (IC) electronics. Moreover, a CMT array directly above the electronics also allows for varying the excitation signal phase to each CMT element thereby enabling beam-forming techniques. Above-IC integration is particularly attractive by not requiring any alteration of the semiconductor fabrication process and allowing subsequent implementation independent of IC fabrication. Naturally, this scheme requires that the CMT technology limit itself to IC compatible materials and chemicals, as well as process step temperatures within a specific thermal budget. Embodiments of the invention expanding upon surface micromachining technology allow the fabrication of IC-compatible CMT structures with superior mechanical properties and resistance to harsh environments such as high temperature, corrosive media and high-g shocks, by exploiting silicon carbide (SiC) structures to form the upper CMT structural layer.

### CROSS-REFERENCE TO RELATED APPLICATIONS

This patent application claims the benefit of U.S. Provisional Patent Application US 61/781,886 filed Mar. 14, 2013 entitled “Methods and Devices relating to Capacitive Micromachined Diaphragms and Transducers.”

### FIELD OF THE INVENTION

This invention relates to microelectromechanical systems and more particularly to capacitive micromachined diaphragms, transducers, and ultrasonic transducers.

### BACKGROUND OF THE INVENTION

Over the past 20 years there has been intensive research on capacitive micromachined transducers (CMT), including capacitive micromachined ultrasonic transducers (CMUT), as compared with piezoelectric transducers (PZT), the lower mechanical impedance of CMT membranes offers the potential for a better impedance match with fluid media. Examples of CMT devices within the prior art include for example Chen et al in “Design and characterization of an air-coupled capacitive ultrasonic sensor fabricated in a CMOS process” (J. Micromechanics and Microengineering, Vol. 18); Doody et al “Modeling and Characterization of CMOS-Fabricated Capacitive Micromachined Ultrasound Transducers” (J. MEMS Systems, Vol. 20, pp. 104-118); Haller et al in “A surface micromachined electrostatic ultrasonic air transducer” (IEEE Trans. Ultrasonics Ferroelectrics and Frequency Control, Vol. 43, pp. 1-6) and Noble et al in “Low-temperature micromachined CMUTs with fully-integrated analogue front-end electronics” (IEEE Int. Ultrasonic Symp., Vol. 1-2, pp. 1045-1050). Further their performance is also less sensitive upon temperature, and they can be easily customized into 1 or 2 dimensional arrays. The fact that they are typically mass-produced using microfabrication techniques that are similar to those used in the semiconductor industry also enables the monolithic integration of CMT with integrated circuits (IC).

The advantages of monolithic integration of CMT together with IC are multiple: shared microfabrication equipment, combined process steps, shared layers, simplified packaging, and reduced die size by overlapping area with the electronics. Performance of the combined system is improved through a reduction of the parasitics, as a result of eliminating the chip-interconnecting wire bonds for example. Moreover, growing the CMT array directly on top of the electronics also allows the possibility of varying the phase of the excitation signal to each CMT element to enable beam-forming techniques. This would be essentially impossible if each element were to be connected to the IC with wire bonds. Among all schemes for integrating CMT directly with electronics, see for example Zahorian et al in “Single chip CMUT arrays with integrated CMOS electronics: Fabrication Process Development and Experimental Results” (IEEE Ultrasonics Symposium, Vol. 1-4, pp. 386-389) and Cheng in “CMUT-in-CMOS ultrasonic transducer arrays with on-chip electronics” (Transducers 2009, pp. 1222-1225), above-IC integration is a very attractive solution because it does not require any alteration of the semiconductor fabrication process. In fact, the CMT can be implemented as a subsequent process module, independent of the IC fabrication. Naturally, this scheme requires that the CMT technology limit itself to IC compatible materials and chemicals, as well as process step temperatures within a specific thermal budget.

Because of their superior mechanical properties and resistance to harsh environments such as high temperature, corrosive media and high-g shocks, silicon carbide (SiC) structures have been successfully used to build strain sensors, pressure sensors, and inertial sensors, see for example Muthu et al in “Silicon Carbide Microsystems for Harsh Environments” (Springer 2011). In the field of CMT, SiC has been demonstrated as an etch-stop layer, see for example Helin et al in “Poly-SiGe-based CMUT array with high acoustic pressure,” (25^{th} Int. Conf. MEMS 2012, pp. 305-308), as a result of its chemical inertness. However, to the inventor's knowledge, CMT built using SiC structural membranes have not been implemented.

In order to make above-IC integration possible, SiC must be deposited at low temperatures. Typical deposition methods of SiC include plasma enhanced chemical vapour deposition (PECVD) and RF sputtering, see for example Ghodssi et al in “MEMS Materials and Processes Handbook” (Springer 2011). Recently, DC-sputtered amorphous SiC films have been used to fabricate high-quality beam resonators, see for example Nabki et al in “Low-Stress CMOS-Compatible Silicon Carbide Surface-Micromachining Technology—Part II: Beam Resonators for MEMS Above IC” (J. Microelectromechanical Systems, Vol. 20, pp. 730-744) (hereinafter Nabki1), RF switches, see for example Cicek et al in “Low actuation voltage silicon carbide RF switches for MEMS above IC” (16^{th} IEEE Int. Conf. Elect., Circuits and Systems 2009, pp. 223-226) and vacuum sensors, see for example Taghvaei et al in “A MEMS-based temperature-compensated vacuum sensor for low-power monolithic integration” (IEEE Int. Symp. Circuits and Systems 2010, pp. 3276-3279). According to embodiments of the invention the inventors have expanded and development upon the surface micromachining technology of Nabki et al in “Low-Stress CMOS-Compatible Silicon Carbide Surface-Micromachining Technology—Part I: Process Development and Characterization” (J. Microelectromechanical Systems, Vol. 20, pp.720-729) (hereinafter Nabki2) to allow the fabrication of IC-compatible CMT structures.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to address limitations of the prior art relating to microelectromechanical systems and more particularly to capacitive micromachined diaphragms, transducers, and ultrasonic transducers.

In accordance with an embodiment of the invention there is provided a device comprising:
a substrate;
a lower electrode disposed on the substrate;
an upper electrode disposed upon the lower surface of a structural member formed above a predetermined portion of the lower electrode, the structural member forming a predetermined portion of a capacitive micromachined transducer (CMT); wherein
the upper and lower electrodes provide electrical excitation of the CMT.

In accordance with an embodiment of the invention there is provided a device comprising a substrate, a lower electrode disposed on the substrate, and an upper electrode disposed upon the lower surface of a structural member formed above a predetermined portion of the lower electrode.

In accordance with an embodiment of the invention there is provided a device comprising:
a substrate;
a plurality of capacitive micromachined transducers (CMTs) formed in predetermined locations upon the substrate, each CMT comprising at least a lower electrode disposed on the substrate and an upper electrode disposed upon the lower surface of a structural member of the CMT formed above a predetermined portion of the lower electrode, wherein the upper and lower electrodes provide electrical excitation of the CMT; and
an electronic circuit, a first predetermined portion of the electronic circuit being below the plurality of CMTs and second predetermined portions of the electronic circuit are electrically connected to the plurality of CMTs during the manufacturing process via a metallization process.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts an exemplary process for manufacturing a SiC-based CMT according to an embodiment of the invention;

FIG. 2A depicts the tuning of residual stress of a 2 μm DC-sputtered SiC film through argon pressure according to the manufacturing process described in respect of FIG. 1;

FIG. 2B depicts a free-standing SiC CMT membrane according to the manufacturing process described in respect of FIG. 1;

FIGS. 3A through 3C depict freestanding SiC membranes fabricated by using release designs of release holes, channel type, and slit-type according to embodiments of the invention;

FIGS. 4A and 4B depict an exemplary process for manufacturing a SiC-based CMT according to an embodiment of the invention;

FIG. 5 depicts SEM images of fabricated CMT membranes according to embodiments of the invention;

FIGS. 6A and 6B depict exemplary process flows for manufacturing the SiC-based CMT membranes according to an embodiment of the invention depicted in FIG. 14;

FIG. 7 depicts simulation results of the amplitude of the harmonic vertical displacement of a CMUT membrane according to an embodiment of the invention;

FIG. 8 depicts the amplitude of the harmonic vertical displacement of a CMUT membrane according to an embodiment of the invention versus frequency for different DC bias voltages;

FIG. 9 depicts simulation results for the mechanical impedance of a CMUT membrane according to an embodiment of the invention versus frequency for different diameter CMUTs;

FIG. 10 depicts an optical micrograph of a packaged CMT test chip and SEM image of the membrane array according to an embodiment of the invention;

FIG. 11 depicts the electrical insertion loss for a CMT according to an embodiment of the invention for varying DC bias;

FIG. 12 depicts the electrical insertion loss for a CMT according to an embodiment of the invention when tested in air and vacuum;

FIGS. 13 and 14 depict a CMT test setup showing alignment configuration and test circuit;

FIGS. 15 and 16 depict experimental results for a CMT according to an embodiment of the invention operated in CW mode;

FIGS. 17 and 18 depict experimental results for a CMT according to an embodiment of the invention operated in pulse mode;

FIG. 19 depicts received signal amplitude versus relative position of a CMUT transducer pair according to an embodiment of the invention in x, y, and z axis;

FIG. 20 depicts the received signal at varying electrical drive for a CMT pair according to an embodiment of the invention;

FIG. 21 depicts CMT membranes deployed within a stacked IC assembly providing inter-chip communications as well as integrated capacitors according to an embodiment of the invention;

FIG. 22 depicts an ultrasonic beam-forming CMT array integrated with signal processing electronics according to an embodiment of the invention;

FIG. 23 depicts a plot of material characteristics to identify materials suitable for exploitation within CMT membranes and devices; and

FIG. 24 depicts a multiple measurand MEMS based circuit for integration atop CMOS electronics according to an embodiment of the invention.

### DETAILED DESCRIPTION

The present invention is directed to microelectromechanical systems and more particularly to capacitive micromachined diaphragms, transducers, and ultrasonic transducers.

The ensuing description provides exemplary embodiment(s) only, and is not intended to limit the scope, applicability or configuration of the disclosure. Rather, the ensuing description of the exemplary embodiment(s) will provide those skilled in the art with an enabling description for implementing an exemplary embodiment. It being understood that various changes may be made in the function and arrangement of elements without departing from the spirit and scope as set forth in the appended claims.

A. Device Fabrication

A.1 Process Flow: Referring to FIG. 1 first to sixth process steps 100A to 100F respectively with respect to manufacturing a CMT according to an embodiment of the invention are depicted exploiting a 5-mask technology process. The process begins for example with a 150 mm silicon substrate covered with a 2 μm-thick thermal silicon dioxide layer (not shown for clarity). In first process step 100A a bottom electrode of 300 nm thick sputtered aluminum (Al) 110 has been patterned and covered with a 500 nm-thick dielectric film made from plasma-enhanced chemical vapor deposited (PECVD) silicon nitride (SiN) (dielectric) 120.

Within this embodiment of the invention a low-temperature-curable polyimide 130, PI-2555 from HD Microsystems, is employed as the sacrificial material. The precursor is first diluted in solvent (T-9030:HD Microsystems) at a 1:1 weight ratio, then spun onto the substrate, and cured at 200° C. for 2 hours. Reactive-ion etching (RIE) is used to pattern the polyimide with oxygen as depicted in second process step 100B. The final thickness of the layer is 450 nm, which establishes the dimension of the CMT electrostatic transduction gap. As depicted in first to sixth process steps 100A through 100F respectively a CMT 100 is depicted in first and second cross-sections X-X and Y-Y respectively.

A top electrode made of 60 nm-thick Al 110 is then sputtered and patterned as depicted in third step 100C. This is followed by the deposition of an 80 nm-thick chromium (Cr) 140 barrier layer, and the deposition and patterning of 300 nm-thick Al bond pads in fourth process step 100D. Next, a 2 μm-thick SiC 150 layer is deposited by DC sputtering and patterned as shown in fifth process step 100E. A metal film, such as Cr 140, can be used as an etch mask for the dry etching of the SiC film using fluorine-based RIE. At this point, the release access ports (holes or slits) to the sacrificial polyimide are also defined in the SiC 150 layer. The previously deposited Cr 140 barrier serves as an etch-stop layer during the SiC 150 dry etch step, in order to protect the underlying layers. After wet removal of the Cr 140 barrier, the SiN 120 layer is dry etched using the patterned SiC as the etch mask, so as to clear the pads for wire bonding. The substrate is then diced into individual CMT chips, which are finally released by removing the sacrificial polyimide in oxygen plasma for 6 hours, see sixth process step 100F.

In order to improve assembly throughput, an alternative sequence avoiding die-level sacrificial release can be used. This method involves the pre-grooving of the wafer substrate to half of its thickness, followed by a wafer level sacrificial release. Mechanical force is finally applied to cleave the wafer into individual dies.

A.2 Process Considerations: Due to the very low allowed thermal budget throughout the process flow presented in FIG. 1 the maximum temperature is maintained at 200° C. for the deposition of PECVD silicon nitride 120 whilst for the DC SiC 150 sputtering the peak temperature does not exceed 170° C. (see Nabki2). In this process, the SiC 150 acts as the critical structural layer of the surface-micromachined CMT. By carefully tuning the argon pressure during the SiC 150 sputtering step a nearly stress-free SiC 150 film can be achieved. By combining the advantages of its inherently high Young's modulus (260 GPa, see Nabki2) and low residual stress (30 MPa, see Nabki2), SiC 150 can be used to form exceptionally large and sturdy suspended membranes, exhibiting little to no deformation at rest. As evident from FIG. 2A where SiC 150 residual stress versus argon pressure during DC sputtering is plotted these SiC films may be stress-free or stressed in either tensile or compressive regimes. As an illustration, FIG. 2B depicts a very thin, 400 nm (0.4 μm), 30 μm-wide CMT membrane is depicted separated from the substrate by a 3 μm gap, all the while maintaining very good flatness.

The choice of polyimide (PI) 130 as a sacrificial material is also of importance. First, the ability to use a dry-release process eliminates the risk of stiction, which is common with wet release methods. Second, an oxygen plasma release, as opposed to a wet etching approach, such as hydrofluoric (HF) acid release, allows for the placement of the upper Al 110 electrode layer directly beneath the SiC membrane, without concerns of it being either attacked or deteriorated through the release process. This optimal proximity of the upper and lower electrodes reduces the transduction gap size, thereby improving electro-mechanical coupling and sensitivity of the CMT.

The design of the release ports is primarily dictated by the size of CMT membrane. Large membranes, for example 500 μm wide or above, generally require densely packed release holes in order to achieve reasonably fast release times, see for example FIG. 3A. However, an adverse effect of release holes in the membrane is that its mechanical integrity can be compromised, which can potentially result in membrane sagging or cracking at critical stress points. For smaller membranes, release ports can be designed as channels connecting the sacrificial material to the exterior, see for example FIG. 3B, or as slit-type openings along the circular edge of a membrane, see FIG. 3C. Within the experiment results presented subsequently the transducers were based on the slit-type design. These devices are expected to exhibit lower mechanical impedances, since they have a softer mechanical support at the membrane periphery. This is especially beneficial when operating the CMUT in a gaseous medium that also has low acoustic impedance. The largest CMUT membrane fabricated by the inventors to date using the slit-type design was 240 μm in diameter.

Since a low mechanical impedance of the membrane is beneficial for efficient ultrasonic power transfer in air, the CMUT prototype employed within the experiments were left unsealed to minimize mechanical loading. However, it would be evident that adding a low-stiffness sealing material, in order to mitigate squeeze-film damping and reduce particle contamination, would allow the CMUT devices to operate within liquid environments.

Now referring to FIGS. 4A and 4B a processing sequence for CMT having release holes in its membrane. Within FIG. 4A first to fourth process steps 400A through 400D are depicted whilst FIG. 4B depicts fifth to eight process steps 400E to 400H respectively. Accordingly, in first process step 400A an initial 60 nm Al 410 film is deposited and patterned. Next in step 400B a 100 nm SiN 420 layer is deposited and patterned, the SiN 120 providing a dielectric layer to prevent the electrodes shorting. Atop this a 1 μm polyimide (PI) 430 layer is deposited and patterned in third step 400C before a 100 nm Al 440 layer is deposited and patterned to provide the second electrode in fourth step 400D. The PI 430 layer forming the sacrificial layer for the subsequent release of the CMT diaphragm.

Next in fifth step 400E the electrode pads are formed by depositing and patterning an 80 nm Cr layer (omitted for clarity) and 300 nm Al3 450 layer. In sixth step 400F the SiC 460 structural layer is deposited and patterned via a Cr hard mask layer, for example 600 nm Cr, which is subsequently etched and removed after the SiC 460 has been patterned. Next in seventh step 400G the PI 430 is etched, releasing the CMT diaphragm. Subsequently a second SiN (SiN2) 470 layer is deposited in eighth process step 400H and patterned although alternatively a silicon oxide (SiO) or silicon oxynitride (SiON) layer may be employed for example.

Referring to FIG. 5 there are depicted first and second CMT structures 500A and 500B respectively exploiting arrayed release holes and slits respectively to facilitate the release of the CMT structure. As depicted first CMT structure 500A is approximately 700 μm square whilst second CMT structure 500B is approximately 90 μm in diameter.

Referring to FIG. 6A there is depicted a first processing sequence comprising first to sixth processing steps 600A through 600F respectively wherein in sixth processing step 600F after the CMT structure has been fabricated a second Sealing SiC 660 layer is deposited and patterned such that the CMT structure is sealed against ingress of materials including but not limited to fluids, such as water for example, and particulates, such as dust for example. The first processing sequence depicted in FIG. 6A representing a CMT structure with slit release features for example. In contrast FIG. 6B depicts a second processing sequence comprising seventh to twelfth processing steps 650A through 650F respectively wherein in twelfth processing step 650F after the CMT structure has been fabricated a second Sealing SiC 660 layer is deposited and patterned such that the CMT structure is sealed against ingress of materials. The second processing sequence depicted in FIG. 6B deviates at tenth processing step 650D wherein the SiC 640 forming the structural layer of the CMT is patterned not for slit type release but arrayed hole release. First to sixth processing steps 600A to 600F respectively and seventh to twelfth processing steps 650A to 650F respectively exploit aluminum (Al) 610, dielectric 620, polyimide (PI) 630, and SiC 640 in common with the processing sequence depicted in FIG. 1.

It would be evident that alternatively other materials rather than silicon carbide may be employed as a sealing layer within CMT/CMUT devices according to embodiments of the invention. As noted a sealing layer allows the use of the CMT/CMUT in liquid media and ionized/partially ionized gaseous media. Optionally, parylene C, a poly(p-xylylene) polymer, would be a good candidate and alternative as a pinhole free insulator, with its very low moisture transmission rate (0.08 g·mm/m²·day) preventing liquid infiltration. Additionally, its low Young's modulus of 2.7 GPa reduces the sealing layers mechanical load on the CMT/CMUT membrane. For applications such as medical imaging that need to be in physical contact with objects, an additional soft protection layer covering the membrane array, such as an encapsulation made of polydimethylsiloxane (PDMS), a silicon-based organic polymer, may be deployed for example.

For vacuum sealing, the sealing layer may be achieved through a variety of techniques including, but not limited to, a high quality inorganic film deposited through PECVD, metal films through sputtering, or solder bumps reflowed in a vacuum environment. Parylene C films may also be employed for vacuum environment sealing provided that the deposition temperature of additional vacuum retention material doesn't surpass the glass transition temperature of Parylene C. A thin film deposited by atomic layer deposition (ALD) offers such a possibility where typical materials that can be deposited by ALD include, but are not limited to, oxides, e.g. alumina (A/₂O₃) and titania (TiO₂), transition-metal nitrides, e.g. titanium nitride (TiN) and tantalum nitride (TaN) and metals, e.g. tungsten (W). Other deposition processes may allow the deposition of other metals and materials including, but not limited to, aluminum, chromium, titanium, tungsten, palladium, platinum, indium tin oxide, and gold.

As noted in respect of FIGS. 6A and 6B supra silicon carbide (SiC) may also be employed as a sealing layer as can other ceramics. The silicon carbide sealing layer may be deposited in a single step or it may alternatively be deposited and patterned in a series of steps.

Referring to Table 1 there are summarized the features of the CMT fabrication technology presented here according to an embodiment of the invention, compared to other reported surface-micromachined CMT processes specifically intended for above-IC integration. Owing to the deliberate selection of appropriate structural and sacrificial materials, the overall temperature budget of the fabrication technology in this work is the lowest reported to date. The high Young's modulus of the structural film, along with its very low residual stress, results in a very sturdy and resilient structure. In addition, the location of the upper electrode directly beneath the membrane brings closer the two capacitive plates therefore results in a more efficient electrostatic transduction gap as opposed to other implementations.

TABLE 1
Comparison of Fabrication Process of Surface-Micromachined CMT Targeting
“above-IC” Approaches

| | | Deposition | | Residual Stress | | | | Max. |
|---|---|---|---|---|---|---|---|---|
| | Structural | | T | (Young's | Electrode | Sacrificial | Release | Temp |
| Ref | Material | Method | (° C.) | Modulus) | Position | Material | Method | (° C.) |
| [A] | SiN | PECVD | 250 | 35 MPa | Between 2 | Si/metal | Wet | 250- |
| | | | | (160 GPa) | Structural | | | 300 |
| | | | | | Layers | | | |
| [B] | SiN | PECVD | 400 | 40-50 MPa | Above | Polyimide | Dry | 400 |
| | | | | (210 GPa) | Membrane | | | |
| [C] | Poly-SiGe | CVD | 340- | −10 MPa | Membrane | Oxide | HF | 475 |
| | | | 475 | (146 GPa) | Itself | | Vapour | |
| Invⁿ | Amporph. | DC | 170 | ±30 MPa | Beneath | Polyimide | Dry | 200 |
| | SiC | Sputter | | (261 GPa) | Membrane | | | |

[A] Knight et al in “Low temperature fabrication of immersion capacitive micromachined ultrasonic transducers on silicon and dielectric substrates” (IEEE Trans. Ultrasonics Ferroelectrics and Frequency Control, Vol. 51, pp. 1324-1333).
[B] Noble et al in “Novel, wide bandwidth, micromachined ultrasonic transducers” (IEEE Trans. Ultrasonics Ferroelectrics and Frequency Control, Vol. 48, pp. 1495-1507).
[C] Helin et al in “Poly-SiGe-based CMUT array with high acoustic pressure,” (25^{th} Int. Conf. MEMS 2012, pp. 305-308).

B: CMUT Modeling and Frequency Domain Studies

The theory and operating principles behind capacitive ultrasonic transducers have been well studied in literature, see for example Ladabaum et al in “Surface Micromachined Capacitive Ultrasonic Transducers” (IEEE Trans. Ultrason. Ferroelectr. Freq. Control, Vol. 45, pp. 678-690), Ergun et al in “Capacitive Micromachined Ultrasonic Transducers: Theory and Technology” (J. Aerosp. Eng., Vol. 16, pp. 76-84), and Cianci et al in “Fabrication Techniques in Micromachined Capacitive Ultrasonic Transducers and their Applications” (MEMS/NEMS, Springer-Verlag, 2006, pp. 353-382). Within the modelling presented here a small signal linear model is used to predict transducer performance in the frequency domain. To actuate a CMUT transmitter, a drive voltage V, consisting of a DC component, V_{DC}, and an AC harmonic component, v_{ac}(t), is applied on the transducer to set the membrane in motion. The voltage applied is thus given by Equation (1) where ωᵢ is the frequency of the AC voltage, and V₀ its amplitude, which is considered to be much smaller than V_{DC}. Modeling the CMUT as a parallel-plate capacitor, the electrostatic actuation force F_{E} exerted on the membrane can be expressed as Equation (2), see Yue et al in “Nonlinear Dynamics Characterisation of Electrostatically Actuated Sub-Micro Beam Resonators” (Proc. SPIE Photoelectronic Detection and Imaging, Vol. 7381, 2009).

$$\begin{matrix} V = {V}_{D C} + {v}_{a c} ( t ) = {V}_{D C} + {V}_{0} sin ( {ω}_{i} t ) & ( 1 ) \\ {F}_{E} = \frac{1}{2} \frac{{ɛ}_{0} {AV}^{2}}{2 {( {d}_{0} - x ( t ) )}^{2}} \approx \frac{1}{2} \frac{{ɛ}_{0} {AV}^{2}}{{d}_{0}^{2}} + \frac{{ɛ}_{0} {AV}^{2}}{{d}_{0}^{3}} x ( t ) \approx ( \frac{{ɛ}_{0} A}{2 {d}_{0}^{2}} + \frac{{ɛ}_{0} A}{{d}_{0}^{3}} x ( t ) ) {V}_{D C}^{2} + ( \frac{{ɛ}_{0} AV}{{d}_{0}^{2}} ) {v}_{a c} ( t ) & ( 2 )\end{matrix}$$

In Equation (2) ε₀ is the vacuum permeability, d₀ is the initial gap height, A is the plate area, x(t) is the vertical membrane displacement, and a first-order Taylor expansion is used for approximation. For a small-signal analysis, one can assume x<<d. Accordingly, the force associated with the AC voltage, i.e. the last term of Equation (2), drives the CMUT and launches ultrasonic waves into the environment.

For a CMUT receiver, only a DC voltage, V_{DC}, is applied to the transducer. Ultrasonic waves carrying a pressure p(t) impinge onto the membrane, which causes a force that modulates the capacitance of the CMUT and generates an AC current. The total force acting on the membrane is given by Equation (3) while the output AC current I due to the capacitance variation is given by Equation (4).

$$\begin{matrix}F = {F}_{E} {\vert}_{{v}_{a c} ( t ) = 0} + p ( t ) A = ( \frac{{ɛ}_{0} A}{2 {d}^{2}} + \frac{{ɛ}_{0} A}{{d}^{3}} x ( t ) ) {V}_{D C}^{2} + ( A ) p ( t ) & ( 3 ) \\ I = {V}_{D C } \frac{d C}{d t} \approx {V}_{D C} \frac{{ɛ}_{0} A}{{d}^{2}} \frac{d x ( t )}{d t} = \frac{{ɛ}_{0} {AV}_{D C}}{{d}^{2}} {x}_{0} ω cos ( ω t ) & ( 4 )\end{matrix}$$

where d is the gap height after the DC bias voltage V_{DC} is applied and the harmonic vertical displacement x(t) is expressed as x₀ sin(ωt).

From Equations (2) and (3), it can be observed that the total force exerted on the membrane for both the transmitting and receiving cases can be modeled as a load established by the transducer's DC operating point and a frequency-domain perturbation. Finite-element method (FEM) analysis was used to physically model the CMUT membranes, with the main objective of evaluating their displacement response in the frequency domain. The physical model of the membrane was simplified to a freestanding circular disk with 4 anchor points, according to the slit-type release port design shown earlier, While damping effects were taken into account through Rayleigh-type modeling, residual stress was neglected due to the inherent low stress of the material deposition recipes used in this process. The potential mechanical impacts of the upper electrode metal layers underneath the membrane were also neglected for simplification, as their thicknesses are much smaller compared to the SiC structural membrane.

Referring to FIG. 7 there is depicted a typical field map for the amplitude of harmonic vertical displacement of a 110 μm actuated membrane indicating a peak vertical displacement of approximately 9 Å. Now referring to FIG. 8 there are presented plots of the amplitude at the central point of the membrane as a function of frequency, for an AC actuation voltage having an amplitude V₀=0.1V. When the AC actuation voltage frequency is centered at the resonant frequency, 1.62 MHz from the simulations, then the maximum displacement at a 20 V DC operating point is about 1.1 nm (11A). FIG. 8 also shows the effect of taking into account spring-softening due to the electrostatic force, see Yue. This spring-softening causes an expected slight shift in the resonant frequency. The mechanical impedance at the central point of the membrane can be defined as the ratio of pressure to velocity at that point. If one assumes a harmonic motion having a frequency-dependent amplitude X(f) that results from a harmonic pressure load p(t) having an amplitude of P₀, the magnitude of the mechanical impedance at the central point can be expressed as Equation (5).

Using Equation (5), one may calculate the membrane impedance at the central point, by obtaining the amplitude of the displacement at that same point with a known pressure load. FIG. 9 presents the simulation results for membranes of diameters 80 μm, 110 μm, and 240 μm. It can be observed that the mechanical impedance of the membrane drops to its lowest when operating at resonances Also, one may note that increasing the membrane diameter results in a decrease of the minimum mechanical impedance of the membrane, which will reduce the impedance mismatch between the membrane and a medium such as air (the acoustic impedance of air at 20° C. is 413.3 kg/m²s).

$$\vert Z ( f ) \vert = \frac{{P}_{0}}{2 π f \cdot X ( f )} \qquad ( 5 )$$

C. Results and Discussion

A typical CMT test die and test structure are depicted in FIG. 10. Each test die measures 6 mm by 6 mm, and the CMT membranes are arrayed hexagonally, with 10 μm spacing, in order to maximize packing density. The membrane diameter was measured to be 109.5 μm, compared with the design value of 110 μm, and there are 631 membranes on each chip. All the devices for which results are presented have a 2 μm membrane thickness and a 450 nm gap size

C.1. Electrical Characterization of CMT Device: A vector network analyzer (VNA) was used to characterize the electrical insertion loss (s₂₁) of the CMT operating in air. FIG. 11 shows a resonance peak at about 1.72 MHz, for a 20 V DC bias and a AC actuation voltage of 0.45 V. Spring softening is clearly observable, as the resonance peak shifts towards lower frequencies for increased bias voltages. A percentage difference of 6% between the observed resonant frequency and the simulated resonant frequency was observed. A damping factor was included in the simulation but might not be accurate enough to portray the actual environmental factors. As for device geometry, the membrane thickness has a significant impact on the resonant frequency of the structure, and it is expected that any film thickness deviations from the simulated value could account for part of the variation in the measured frequency. Also, since only low-resolution, 8 μm feature size, photomasks were used for process development, there may have been discrepancies between the projected and fabricated dimensions of the membranes. This can result in resonant frequency disparities. A high-resolution photomask, at least for the critical SiC structural layer, is expected to significantly decrease these variations.

When attempting to increase the DC bias above 40 V, breakdown of the interconnect-passivating silicon nitride dielectric was observed. This is attributable to the low breakdown voltage of the PECVD silicon nitride films used in the fabrication process. Consequently, the total instantaneous voltage applied to the CMUT transducers was kept below 40 V in all subsequent experiments.

Since the CMUT transducers testing were not sealed, the effect of squeeze-film damping when operating the device in air was investigated, as it could affect the quality (Q) factor and resonant frequency of the device. Accordingly, the impact of air damping on the Q-factor and resonant frequency of the CMUT transducers was verified by comparing the electrical insertion loss of the devices in air and in vacuum, as shown in FIG. 12. In the vacuum environment, achieved by testing the unsealed transducer in a vacuum chamber at below 0.01 mbar, air damping effects such as squeeze-film damping are eliminated. In air, squeeze-film damping effects are present, explaining the different transmission response shown in FIG. 12.

In comparison to the single-transducer Q-factor of 4.38 in air, eliminating squeeze-film damping yields a marginal improvement of the Q-factor to 4.56. This indicates that energy losses that dominate in this structure are linked to other mechanisms such as thermo-elastic damping or anchor losses, and thus the Q-factor is not significantly impacted by squeeze-film or viscous air damping.

While the Q-factor of the device cannot be used to clearly estimate the extent to which squeeze-film damping affects it, the resonant frequency shift that it exhibits between air and vacuum ambient conditions is more indicative. As can be seen in FIG. 12, there is a significant impact on the resonant frequency, as it varies from 1.72 MHz in air to 1.21 MHz in vacuum. The decrease in frequency from an air to a vacuum environment implies that squeeze-film damping affects the device significantly. This can be explained by briefly exposing key elements of squeeze-film theory. For this CMUT structure, σ, the squeeze number in air of a circular membrane with radius a is given by Equation (6), see Hansen et al in “Characterization of Capacitive Micromachined Ultrasonic Transducer in Air using Optical Measurements” (Proc. SPIE Ultrason. Symp. Vol. 1, 2000, pp. 947-950), where μ is the viscosity of air, ω is the angular frequency, d is the gap size and p₀ is the atmospheric pressure. The squeeze number is accordingly calculated to be 342 in air for the tested CMUT device in the vicinity of its resonant frequency, with a 450 nm gap size and a 110 μm diameter. Referring to Bao et al in “Squeeze Film Air Damping in MEMS” (Sens. Actuators A, Phs., Vol. 136, pp. 3-27) it can be shown that the amplitude of the harmonic displacement of the CMUT device, x₀, as a function of frequency can be given by Equation (7) where F_{E0} is the amplitude of the applied harmonic electrostatic force, k is the CMUT membrane effective spring constant, and m is its effective mass. c_{d} is the coefficient of viscous damping force, k_{d} is the coefficient of elastic damping force, both a function of the squeeze number and defined through the mode shape of the CMUT membrane, see Bao, and given by Equations (8A) and (8B) respectively.

$$\begin{matrix}σ = \frac{12 μ {a}^{2} ω}{{p}_{0} {d}^{2}} & ( 6 ) \\ {x}_{0} ( ω ) = \frac{{F}_{E 0}}{m} \sqrt{\frac{1}{{[ \frac{{( k + {k}_{d} )}^{2}}{{m}^{2}} - {ω}^{2} ]}^{2} + \frac{{c}_{d} {ω}^{2}}{{m}^{2}}}} & ( 7 ) \\ {k}_{d} ( σ ) ∝ \frac{{σ}^{2} {p}_{0} A}{d} {\sum }_{n = odd} \frac{1}{{n}^{2} ( {n}^{4} + ( {σ}^{2} / {π}^{4} ) )} & ( 8 A ) \\ {c}_{d} ( σ ) ∝ \frac{σ {p}_{0} A}{d ω} {\sum }_{n = odd} \frac{1}{( {n}^{4} + ( {σ}^{2} / {π}^{4} ) )} & ( 8 B ) \\ ω = {ω}_{0} \sqrt{{( 1 + \frac{{k}_{d}}{k} )}^{2} - \frac{{c}_{d}^{2}}{2 k m}} & ( 9 )\end{matrix}$$

It can be shown by finding the maxima of Equation (7) that the resonant frequency when taking into account squeeze-film damping is given by Equation (9) where ω₀ is the resonant frequency of the CMUT without any damping (i.e., in vacuum). According to squeeze-film damping theory, see Bao, the large squeeze number (>>20) indicates that the squeeze-film damping is dominated by the elastic damping force, as opposed to a viscous damping force, due to the sufficiently fast air compression within the narrow transducer gap causing a compressible gas condition (i.e., operation beyond the squeeze number cut-off frequency). As such, this implies that k_{d}/k in Equation (9) is sufficiently large to increase the resonant frequency in air, as seen in FIG. 12. This contrasts the typical decrease in resonant frequency seen in air when viscous damping dominates in cases where the squeeze number is very small, and the air behaves in an incompressible fashion.

For a sealed device, the vacuum region would only be situated on one side of the vibrating membrane, with the air environment on the other side, indicating that the frequency shift seen in FIG. 12 constitutes a worst-case boundary. Ultimately, if this shift is taken into account during design, the effect of squeeze-film damping on the device is marginal because it does not significantly affect the Q-factor of the device or its transmission impedance, as corroborated by FIG. 12. It is to be noted that CMUT Q-factors are typically low, allowing the CMUT devices to operate across a relatively wide frequency band.

C.2. Acoustic Characterization of a CMT Device in Air: A pitch-and-catch configuration was used to test the acoustic behavior of the transducers in air. To achieve sufficient leveling and alignment between the active surfaces of the transmitter and receiver, an alignment system was built using kinematic mounting platforms, as shown on FIG. 13. FIG. 14 shows the corresponding electrical test setup configuration wherein a transimpedance amplifier (TIA) with a gain of 68 dB was used for signal amplification when necessary. The output signal from the amplifier was filtered by a low pass filter with pass band from DC to 5 MHz. With the transmitter and receiver separation set to 10 mm, the transmitter was excited with a 20V continuous sinusoidal wave at the transducer's resonant frequency to send an acoustic signal to the receiver. DC biasing for both the transmitter and receiver was set to 20V. The received signal measured with a spectrum analyzer without amplification from the TIA is shown in FIG. 15. A sharp peak is observed at the frequency of the input signal at the transmitter. Varying the input signal frequency obtains the transmission frequency response for the combined transmitter/air-gap/receiver system as depicted in FIG. 16. Peak transmission (−46 dB) was observed at a frequency of about 1.75 MHz, marking the center frequency of the setup. After compensating the plot for sound attenuation in air, see for example Bond et al in “Absorption of Ultrasonic-Waves in Air at High-Frequencies (10-20 MHz)” (J. Acoustical Society of America, Vol. 92, pp. 2006-2015), the maximum transmission gain becomes −38 dB, with very little variation in terms of center frequency. The measured 3dB bandwidth as result of compensating for sound attenuation increased slightly from 0.11 MHz to 0.15 MHz. The Q-factor of the system was calculated as being approximately 16 using Equation (10) where f₀ is the centre frequency and f_{H} and f_{L} are the higher and lower 3 dB frequencies respectively.

$$Q = \frac{{f}_{0}}{{f}_{H} - {f}_{L}} \qquad ( 10 )$$

FIGS. 17 and 18 illustrate the system behavior for a 5V pulsed input signal at the transmitter, with a low repetition rate of 7.9 kHz and a pulse width of 180 ns. Both transmitter and receiver were biased at 20 V, and separated by 10 mm. A TIA was used for amplification of the received signal in order to compensate for the higher noise floor of the time domain oscilloscope used. Using this distance and the time of flight (29 μs) obtained by comparing the pulse signal and received signal, the velocity of ultrasound can be calculated to be around 345 m/s, as expected. Extracting the Q-factor from the received waveform by calculating the decay factor of each pulse response, see Christensen in Ultrasonic Bioinstrumentation (Wiley, 1988, pp. 82-85), yields a value of approximately 16, matching the value previously obtained from the continuous wave frequency response. The decay time for the pulse response is somewhat longer than found in the prior art for an air-coupled CMUT, see Ergun. This higher Q-factor can be attributed to the high stiffness of the SiC membrane and to the membrane dimensions. Notably, the stiffer structure reduces the proportion of energy lost due to air damping with respect to the stored mechanical energy.

The ultrasound radiation pattern was investigated by keeping the same pitch-and-catch configuration but displacing the CMUT receiver in the x, y, and z directions independently. The boundary for near field and far field of the CMUT transmitter was calculated to be around 16 mm, therefore the initial distance between the transmitter and the receiver was adjusted to be 22 mm, in order to ensure that the receiver was located within the far-field region of the emitted ultrasound wave. A 1.7 MHz sinusoidal wave with an amplitude of 20 V was used to excite the transmitter while a 20 V DC bias was applied to both transmitter and receiver. Again, a TIA was used for amplification of the received signal. FIG. 19 depicts the measured results showing that the received signal drops consistently with distance along the Z-axis, as expected. However, some slight asymmetry is observed for the x and y-axis scans. This may be caused by initial alignment inaccuracy, considering the short wavelength of the emitted ultrasound (about 200 μm). The hexagonal shape of the CMUT array may also be a contributing cause to this observation.

With above-1C integration in mind, the possibility of powering the CMUT using IC electronics was also investigated, through a series of tests using the pitch-and-catch system in CW mode. Lower biasing and actuation voltages, more suited to IC operation, were used. A maximum of 5 V was used as the DC bias for the transmitter and the receiver, as well as for the peak-to-peak AC signal at the transmitter. FIG. 20 depicts the received signal amplitude at 3, 4 and 5 V respectively (with TIA amplification), when the transducer and receiver were separated by a distance of 8 mm. The amplitude received is expectedly lower, but the operation of the devices is still clearly viable. It would be evident that the received signal strength can be further enhanced by monolithically integrating the CMUT above the driving electronics, which reduces losses due to interconnection parasitics. Furthermore, additional electronic amplification can be applied to the output signal of the receiver within an integrated sensing circuit.

D: Extensions

It would be evident to one skilled in the art that the first and second processing sequences depicted in FIGS. 1, 4A, 4B, 6A, and 6B respectively may be employed to form large area capacitors as part of the integrated circuit above which they are fabricated with a low temperature process. Assuming a parallel plate capacitor to provide an approximation of the capacitance it would be evident to one skilled in the art that the capacitance, C, increases linearly with area (A) (which goes as the square of side length l for a square parallel plate design) and inversely with plate separation (d). Accordingly, CMT structures with large square diaphragms and low electrode separations provide for high capacitance. Additionally, multiple large area CMT based capacitors may be electrically interconnected in parallel to further increase capacitance. With above IC manufacturing processes it would be evident to one skilled in the art that the whole die footprint except that required for bondpad access is therefore essentially accessible to provide capacitor structures for the devices operation thereby removing the requirement for external capacitors.

Now referring to FIG. 21 there is depicted a schematic of exploitation of CMT structures within a multi-circuit stacked electronics assembly. As depicted first and second substrates 2150 and 2170 respectively comprising first and second CMT structures 2110 through 2130 upon first substrate 2150 and third and fourth CMT structures 2120 and 2140 respectively upon second substrate 2170 are disposed opposite each other. First and third CMT structures 2110 and 2120 respectively represent CMT transceivers whilst second and fourth CMT structures 2130 and 2140 respectively CMT capacitors. As depicted first and third CMT structures 2110 and 2130 respectively are coupled to first and second circuit elements 2160A and 2160B respectively whilst second and fourth CMT structures 2130 and 2140 respectively are coupled to third and fourth circuit elements 2180A and 2180B respectively. First and second circuit elements 2160A and 2160B respectively may form part of the same electronic circuit or they may represent different electronic circuits. Similarly second and fourth CMT structures 2130 and 2140 respectively may form part of the same electronic circuit or they may represent different electronic circuits.

Accordingly, first and second CMT structures 2110 and 2130 may provide ultrasonic transmission of data between first circuit element 2160A in first substrate 2150 and third circuit element 2180A in second substrate 2170. Such data transmission may be unidirectional and/or bidirectional. In addition to direct communication first and second CMTs may provide characterization and assessment of a fluid between them or ultrasonic imaging based upon attenuation between elements of an array of transducers. Alternatively, a single integrated circuit with an array of CMT transceivers may be employed to provide ultrasonic imaging based upon pulsed operation of the CMT transceivers. Further, multiple CMTs may be combined with appropriate phase offsets to provide a beam-formed ultrasonic probe beam. Such an array of CMTs is depicted in FIG. 22 by SEM micrograph 2250 and in cross-section 2200 wherein the array of CMT devices 2230A through 2230N are fabricated onto the surface of a substrate 2210 which includes CMOS circuit 2220 which provides the multiple drive signals to the array of CMT devices 2230A through 2230N with their appropriate phase shifts. It would be evident that the resulting integrated circuit provides for either continuous emission and/or pulsed transmission. In the later the array of CMT devices 2230A through 2230N may also in some embodiments of the invention also act as an array of receivers. Accordingly an ultrasonic device operating under continuous wave (CW) and/or pulse mode may be formed using manufacturing techniques according to embodiments of the invention.

Accordingly, the inventors have demonstrated novel SiC-based CMT structures fabricated using an above-IC-compatible surface micromachining process. Further devices manufactured according to embodiments of the invention have been tested with IC-compatible voltage levels to validate their use in above-IC scenarios. Accordingly, the embodiments of the invention provide validation of the proposed fabrication technology and demonstrate the first SiC-based CMT. The low temperature, <200° C., of the manufacturing process, as well as its chemical compatibility, will enable the integration of CMT directly above-IC for smart and versatile ultrasonic systems, resulting in lower cost, smaller form factor and greater performance.

Whilst the embodiments of the invention described above in respect of FIGS. 1 through 22 silicon carbide (SiC) has been described as the material of choice for the structural elements of the CMT structures. Referring to FIG. 23 there shown is a material selection chart for MEMS device implementations. Plotted onto the material selection chart are a range of different materials including metals, dielectrics, ceramics and polymers. Each material being represented by a point on the X-Y graph wherein the X-axis is density and Young's modulus is the Y-axis. The data being plotted is according to the work of Srikar et al “Materials Selection in Micro-Mechanical Design: An Application of the Ashby Approach” (J. Microelectromechanical Systems Vol. 10, No. 1, pp. 3-10). As acoustic velocity, a factor governing the resonant frequency of structural materials, is determined in accordance to Equation 1 below, wherein ρ is density and E Young's modulus, there are also depicted lines of constant acoustic velocity 131, 132, 133 of 1×10³ ms⁻¹, 3×10³ ms⁻¹, and 1×10⁴ ms⁻¹ respectively.

υ=\sqrt{E/ρ} (11)

As evident from the material selection chart, different types of materials tend to be grouped together. Ceramic materials 2340 tending to appear in the top left, metals 2350 appearing in the middle-right, whilst polymers and elastomers 2320 are grouped together in the bottom-left. The trend arrow 2310 indicates the direction of preference for selecting materials for MEMS application in having high Young's modulus and low density. Accordingly, from the material selection chart alternatives to silicon (Si) for forming structural elements in resonant/acoustic/ultrasonic structures include silicon carbide (SiC) as discussed supra in respect of embodiments of the invention but also alumina (Al2O3), diamond (C), and silica nitride (Si3N4 or commonly SiN such as employed supra for simplicity). Accordingly, embodiments of the invention may also be implemented using designs and processes discussed supra in respect of FIGS. 1 through 23 using membranes selected from the group comprising silicon, silicon dioxide, silicon nitride, silicon oxynitride, carbon, aluminum oxide, and silicon carbide.

As discussed supra in respect of embodiments of the invention the CMT/CMUT devices in active device configurations require the interconnection of the CMT/CMUT device to an electrical circuit, e.g. bias voltage, data signal, pulse signal, etc. as well as routing from a sensor to post-processing circuitry. In some instances rather than a discrete CMT/CMUT device or a small number of relatively well separated CMT/CMUT devices there may be a large number of CMT/CMUT devices such as to provide a steerable ultrasonic output signal or a directionally settable receiver. In these instances a significant number of electrical connections may be necessary and require interconnection to control and processing electronics beside and/or below the CMT/CMUT device array.

The inventors have previously established innovative manufacturing sequences that are compatible with the process flows described supra in respect of in FIGS. 1, 4A, 4B, 6A, and 6B respectively which support complex electrical interconnections and metallization by allowing:
the sidewalls of MEMS structures including active elements of MEMS devices to support sidewall metallization;
the lower surfaces of MEMS elements to be metallized and electrically connected to the substrate either through direct interconnection via the underside of the MEMS element or through wrap-around metallization from the lower surface of the MEMS element to the upper surface; and
provisioning of vias and feed-throughs incorporating metallization and ceramic re-inforcement.

Such metallization, via, feed-through and MEMS manufacturing process flows for example including U.S. Pat. No. 8,658,452 entitled “Low Temperature Ceramic Microelectromechanical Structures”, U.S. Pat. No. 8,071,411 “Low Temperature Ceramic Microelectromechanical Structures”, U.S. Pat. No. 8,409,901 entitled “Low Temperature Wafer Level Processing for MEMS Devices”, US Patent Application 2013/0,115,7530 entitled “Low Temperature Wafer Level Processing for MEMS Devices”

As noted supra in respect of descriptions and comments relating to embodiments of the invention and its concepts in respect of FIGS. 1 to 23 the compatibility of the manufacturing sequences in FIGS. 1, 4A, 4B, 6A, and 6B respectively to implementing multiple MEMS based devices upon the same substrate was described. Referring to FIG. 24 there is depicted a circuit 2400 comprising first to ninth MEMS 2400A to 2400H respectively which are also shown in first and second cross-sections X-X and Y-Y respectively. These MEMS elements being a reference humidity element 2400A, MEMS humidity sensor 2400B, MEMS pressure sensor 2400C, first clamped beam MEMS resonator 2400D, second clamped beam MEMS resonator 2400E, reference MEMS flow sensor 2400F, MEMS flow sensor 2400G, MEMS gyroscope 2400H, and MEMS CMUT 24001.

E: Other Applications

Within the description supra in respect of FIGS. 1 to 23 reference has been made to the CMT diaphragms from the perspective of capacitive micromachined ultrasonic transducers (CMUTs). However it would be evident to one skilled in the art that the CMT diaphragms and transducers described supra in respect of embodiments of the invention may be exploited within a variety of other devices including, but not limited to, pressure sensors, altimeters, capacitors, tactile pressure, keypads, and other MEMS. It would also be evident that the fabrication processes described supra in respect of embodiments of the invention are such that the CMT/CMUT devices can be fabricated with minor modifications simultaneously. Such other devices may include, but are not limited, to MEMS pressure sensors, MEMS microphones, MEMS temperature sensors, and MEMS actuators such that a circuit may adjust an aspect of its setting in response to either data transmitted to the circuit, such as via CMUT interface, or adjust an aspect of its operation to control a system. It would also be evident that the sealing processes described supra in respect of the fabrication of MEMS CMUT devices with ceramic layers may also be applied to the aforementioned MEMS microphone and pressure sensors for example.

Examples of other applications of CMTs/CMUTs include, but are not limited to, those relating to:

Sonic Transducers: The CMTs by virtue of their flexibility in design with respect to diameter, geometry etc. may be designed to provide transducers for a wide range of frequencies. Consideration of equivalent circuit models of CMTs/CMUTs then there are several impedances, including membrane mechanical impedance, acoustic load impedance, and transducer losses, that are all dependent upon the area of the CMUT. Accordingly, the operating frequency can be rapidly varied through variations in the dimensions of the CMT/CMUT as for square and circular/hexagonal/octagonal etc. CMTs/CMUTs these will therefore vary according to a square law.

Acoustic Doppler Velocity Measurement: Integrated transmitter/receiver Doppler measurement devices may be implemented using CMUTs allowing non-optical based velocimetry techniques to be applied to a variety of test, measurement, analysis, and monitoring applications.

High-Temperature Non-Destructive Testing (NDT): Within the breadth of commercial sensor products those that operate at temperatures up to 250° C. are considered to be high-temperature sensors. Due to the properties of the CMTs/CMUTs in terms of a ceramic transduction element, e.g. SiC, and the potential to exploit silicon and other substrates including silicon-on-sapphire/silicon-on-insulator, and different metallization schemes then the CMUT devices manufactured according to embodiments of this invention will be able to withstand temperatures well above the 250° C. limit. In fact, these will generally be restrained by the melting point of the metallization layer used, which could be any metal that can be sputtered or evaporated. Accordingly, CMT/CMUT devices according to embodiments of the invention may be exploited for NDT applications in true high-temperature environments including, but not limited to, inside gas turbines, internal combustion engines, ovens, furnaces, combustion systems, distillation and cracking operations, etc.

Non-Contact NDT: Many samples to characterised should not be placed in direct contact with an ultrasonic transducer, for example due to an elevated surface temperature of the sample being characterised or non-compatibility of the sample with gel-type coupling layers normally employed. In contrast, low-impedance membrane-type CMUT devices provide an effective solution to this problem as the ambient air, instead of a gel, now serves to couple the transducers to the sample surface without contact. Additionally, due to the arrayed nature of the fabrication process measuring multiple locations of a sample is very quick without any mechanical impediment and/or motion requirement. This can have particular use in biomedical applications for instance.

Short-Range Distance Sensing: Short-distance measurement in air is usually difficult to achieve since, based on the time-of-flight principle, it requires the transducer to have a narrow pulse response and operate at a higher frequency to obtain sufficient measurement accuracy. The SiC-based CMUT developed in this work was able to measure several centimeters at a comparably high frequency. 1.7 MHz, in air. Whilst the CMTs/CMUTs would require design adjustments to match the specifications for real-world applications as outlined supra the operating frequency can be easily and rapidly scaled through simple dimensional adjustments. Further these devices allow the CMTs/CMUTs to be directly integrated with ICs, e.g. CMOS ICs as well as being formed into phased arrays thereby making these devices of interest in high-precision proximity sensors. One such are with large-scale deployment for such sensors is contactless gesture control for smartphones, tablets, and other hands free interfaces.

Gas Flow Rate Measurement: Within the prior art ultrasonic flow meters are known to exhibit inaccuracies due to high-frequency noise generated near pressure regulators in gas pipelines, in the range of 80-200 kHz, close to the working frequency of typical piezoelectric ultrasonic transducer. Accordingly, one solution to this issue is to use transducers operating at higher frequencies, making the measurement system less sensitive to the noise/acoustic interference, while also improving measurement accuracy. Accordingly, SiC-based CMUT developed in this work can help create more reliable flow meters in applications such as natural gas metering or industrial process control.

Measurement of Gas Leaks: In many applications leaks present a significant risk even at extremely low leaks. In many instances micro-cracks and other leak sources in combination with the flow of a liquid/gas through the leak will generate ultrasonic signals. Accordingly, CMUTs provide the ability to monitor high frequency leak generated ultrasonic waves in small footprint, low cost solutions allowing their deployment in a wide range of biochemical, pharmaceutical, chemical processing applications as well as general commercial/residential use.

Relative Humidity/Fluid Composition Sensing: The acoustic velocity of air varies with humidity. Similarly, the acoustic velocity of a fluid, e.g. one comprising two or more gases or liquids, may vary according to the composition of the fluid. Accordingly, this velocity variation can be determined using time of flight measurements from CMT/CMUT devices. Equally, the density of a fluid varies with temperature and accordingly CMT/CMUT time of flight data can be used to monitor fluid temperatures through NDT approaches.

Near-Field Data Transmission: In the majority of control and data applications despite the data rate of data transmission is quite low even if it is carried on wireless/microwave carriers. In many applications the communications are in fact required to be only short range/near field. Accordingly, ultrasonic transducers can be employed to transmit data at inaudible ranges over short ranges in a wide range of applications including sensor integration within personal area networks etc.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments. Implementation of the techniques, blocks, steps and means described above may be done in various ways. Also, it is noted that the embodiments may be described as a process which is depicted as a flowchart, a flow diagram, a data flow diagram, a structure diagram, or a block diagram. Although a flowchart may describe the operations as a sequential process, operations may in some instances be performed in parallel or concurrently. In addition, the order of the operations may in some instances be rearranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A device comprising:
a substrate;
a lower electrode disposed on the substrate;
an upper electrode disposed upon the lower surface of a structural member formed above a predetermined portion of the lower electrode, the structural member forming a predetermined portion of a capacitive micromachined transducer (CMT); wherein
the upper and lower electrodes provide electrical excitation of the CMT.

2. The device according to claim 1 wherein,
the substrate comprises an electronic circuit, a first predetermined portion of the electronic circuit being below the device and a second predetermined portion of the electronic circuit is electrically connected to the CMT during the manufacturing process via a metallization process.

3. The device according to claim 1 wherein;
the structural member is formed from a material selected from the group comprising carbon, aluminum oxide, and silicon carbide.

4. The device according to claim 2 wherein,
the manufacturing process for the CMT limits the maximum temperature of the electronic circuit to below at least one of 200° C., 250° C., 300° C., 350° C., and 400° C.

5. The device according to claim 1 further comprising;
a capping layer deposited atop the device and sealing the gap between the upper and lower electrodes from the external environment.

6. The device according to claim 5 wherein,
the capping layer is formed from a material selected from the group comprising silicon, silicon dioxide, silicon nitride, silicon oxynitride, carbon, aluminum oxide, silicon carbide, parylene and a fluorocarbon.

7. The device according to claim 1 wherein,
the structural member comprises a release feature, the release feature allowing removal of a sacrificial layer to release a predetermined portion of the structural member from the substrate during manufacturing and comprising at least one of:
a plurality of holes through the thickness of the structural member disposed across the structural member;
a plurality of channels formed in the lower surface of the structural member, each channel starting a first predetermined point relative to the centre of the structural member and running to the periphery of the structural member; and
a plurality of slits through the thickness of the structural member, each slit starting at a second predetermined point on the structural member and ending at a third predetermined point on the structural member.

8. A capacitor comprising:
a substrate;
a lower electrode disposed on the substrate;
an upper electrode disposed upon the lower surface of a structural member formed above a predetermined portion of the lower electrode.

9. The device according to claim 8 wherein,
the substrate comprises an electronic circuit, a first predetermined portion of the electronic circuit being below the device and a second predetermined portion of the electronic circuit is electrically connected to the CMT during the manufacturing process via a metallization process.

10. The device according to claim 8 wherein;
the structural member is formed from a material selected from the group comprising carbon, aluminum oxide, and silicon carbide.

11. The device according to claim 9 wherein,
the manufacturing process for the CMT limits the maximum temperature of the electronic circuit to below at least one of 200° C., 250° C., 300° C., 350° C., and 400° C.

12. The device according to claim 8 further comprising;
a capping layer deposited atop the device and sealing the gap between the upper and lower electrodes from the external environment.

13. The device according to claim 12 wherein,
the capping layer is formed from a material selected from the group comprising silicon, silicon dioxide, silicon nitride, silicon oxynitride, carbon, aluminum oxide, silicon carbide, parylene C, a fluorocarbon, aluminum, chromium, titanium, tungsten, palladium, platinum, indium tin oxide, and gold.

14. The device according to claim 8 wherein,
the structural member comprises a plurality of holes through the thickness of the structural member disposed across the structural member, the plurality of holes allowing removal of a sacrificial layer releasing a predetermined portion of the structural member from the substrate.

15. A device comprising:
a substrate;
a plurality of capacitive micromachined transducers (CMTs) formed in predetermined locations upon the substrate, each CMT comprising at least a lower electrode disposed on the substrate and an upper electrode disposed upon the lower surface of a structural member of the CMT formed above a predetermined portion of the lower electrode, wherein the upper and lower electrodes provide electrical excitation of the CMT; and
an electronic circuit, a first predetermined portion of the electronic circuit being below the plurality of CMTs and second predetermined portions of the electronic circuit are electrically connected to the plurality of CMTs during the manufacturing process via a metallization process.

16. The device according to claim 15 wherein,
the structural member is formed from a material selected from the group comprising carbon, aluminum oxide, and silicon carbide.

17. The device according to claim 15 wherein,
the manufacturing process for the CMT limits the maximum temperature of the electronic circuit to below at least one of 200° C., 250° C., 300° C., 350° C., and 400° C.

18. The device according to claim 15 further comprising;
a capping layer deposited atop the device and sealing the gap between the upper and lower electrodes from the external environment.

19. The device according to claim 18 wherein,
the capping layer is formed from a material selected from the group comprising silicon, silicon dioxide, silicon nitride, silicon oxynitride, carbon, aluminum oxide, silicon carbide, parylene C, a fluorocarbon, aluminum, chromium, titanium, tungsten, palladium, platinum, indium tin oxide, and gold.

20. The device according to claim 15 wherein,
the structural member comprises a release feature, the release feature allowing removal of a sacrificial layer to release a predetermined portion of the structural member from the substrate during manufacturing and comprising at least one of:
a plurality of holes through the thickness of the structural member disposed across the structural member;
a plurality of channels formed in the lower surface of the structural member, each channel starting a first predetermined point relative to the centre of the structural member and running to the periphery of the structural member; and
a plurality of slits through the thickness of the structural member, each slit starting at a second predetermined point on the structural member and ending at a third predetermined point on the structural member.
